(19) United States
(12) Patent Application Publication
(10) Pub. No.: US 2016/0329626 A1
(43) Pub. Date: Nov. 10, 2016

(54) RADIATOR FRAME HAVING ANTENNA PATTERN AND METHOD OF MAKING THE SAME

(71) Applicant: SAMSUNG ELECTRO-MECHANICS CO., LTD., Suwon-si (KR)

(72) Inventors: Dae Seong JEON, Suwon-si (KR); Hyun Sam MUN, Suwon-si (KR); Sung Eun CHO, Suwon-si (KR); Hyeon Gil NAM, Suwon-si (KR)

(73) Assignee: SAMSUNG ELECTRO-MECHANICS CO., LTD., Suwon-si (KR)

(21) Appl. No.: 15/040,097

(22) Filed: Feb. 10, 2016

(30) Foreign Application Priority Data
May 4, 2015 (KR) 10-2015-0062730

(51) Int. Cl. H01Q 1/24

(52) U.S. Cl. CPC H01Q 1/243

(57) ABSTRACT

A radiator frame includes a molded frame; a connection terminal extending from one surface of the molded frame and through another surface thereof; an extension frame substantially surrounding the molded frame; and an antenna pattern extending from the one surface of the molded frame to one surface of the extension frame and electrically connected to the connection terminal.

### CROSS-REFERENCE TO RELATED APPLICATION

This application claims the benefit under 35 USC 119(a) of Korean Patent Application No. 10-2015-0062730 filed on May 4, 2015, with the Korean Intellectual Property Office, the entire disclosure of which is incorporated herein by reference for all purposes.

### BACKGROUND

1. Field

The following description relates to a radiator frame including an antenna pattern, and an electronic device including the same.

2. Description of Related Art

Mobile communications devices supporting wireless communications, such as mobile phones, personal digital assistants (PDAs), navigation devices, and laptop computers, are important devices which are indispensible in modern society. Mobile communications devices are evolving at present, and the ability to undertake communications using a range of communications standards, such as code division multiple access (CDMA), wireless LAN, global system for mobile communications (GSM), and digital multimedia broadcast (DMB), are being provided therein. One important component allowing mobile communications devices to have such functions is an antenna.

External type antennas are vulnerable to external impacts, while antennas embedded in an electronic device may increase the size of mobile communications apparatuses. In order to solve such problems, integration of antennas with mobile communications devices are being actively studied.

Normally, a radiator is fabricated by forming a radiator frame using an injection molding process. However, when the radiator is fabricated through an injection molding process, the radiator including an antenna pattern and a terminal needs to be injection-molded as a whole. Therefore, a manufacturing yield may be reduced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a radiator frame includes a molded frame; a connection terminal extending from one surface of the molded frame and through another surface thereof; an extension frame substantially surrounding the molded frame; and an antenna pattern extending from the one surface of the molded frame to one surface of the extension frame and electrically connected to the connection terminal.

The connection terminal includes a contact-extension part extending along the molded frame and exposed on the one surface of the molded frame and in contact with the antenna pattern, a connection part extending through the molded frame from one end of the contact-extension part through the other surface of the molded frame, and a terminal part extending from one end of the connection part parallel to the other surface of the molded frame. The antenna pattern is connected to at least a portion of the contact-extension part. The connection terminal may have an ‘C’, or a stepped shape. Alternatively, the connection terminal includes only a connection part and a terminal part and have an ‘L’ shape.

In another general aspect, an electronic device, includes an electronic device case; a radiator frame installed in the electronic device case; and a circuit board electrically connected to the radiator frame configured to receive a signal from the radiator frame or transmit a signal to the radiator frame, wherein the radiator frame includes a molded frame, a connection terminal extending from one surface of the molded frame and through another surface thereof, an extension frame substantially surrounding the molded frame, and an antenna pattern extending from the one surface of the molded frame to one surface of the extension frame and electrically connected to the connection terminal.

In another general aspect, a method of fabricating a radiator frame includes injection-molding a molded frame around a connection terminal; injection-molding an extension frame around the molded frame; disposing an antenna pattern in a groove pattern formed on an upper surface of the molded frame and extension frame. The antenna pattern may be disposed on the upper surface of the molded frame and the one surface of the extension frame by screen-printing or electroplating using a conductive material and connected to the connection terminal.

Other features and aspects will be apparent from the following detailed description, the drawings, and the claims.

### BRIEF DESCRIPTION OF DRAWINGS

FIG. 1 is a schematic perspective view illustrating a radiator frame coupled to a case of a mobile communications apparatus according to one or more embodiments;

FIG. 2 is an exploded perspective view schematically illustrating a mobile communications apparatus having a radiator frame according to one or more embodiments;

FIG. 3 is a schematic perspective view illustrating a connection terminal of a radiator frame according to one or more embodiments;

FIG. 4 is a schematic perspective view illustrating a radiator frame according to one or more embodiments;

FIG. 5 is a schematic cross-sectional view taken along line A-A′ of FIG. 4;

FIG. 6 is an exploded perspective view illustrating a radiator frame separated into a molded frame and an extension frame, without an antenna pattern, according to one or more embodiments;

FIG. 7 is an exploded perspective view illustrating a radiator frame separated into a molding frame and an extension frame, without an antenna pattern, according to another embodiment;

FIG. 8 is a schematic perspective view illustrating a connection terminal of a radiator frame according to another embodiment;

FIG. 9 is a schematic perspective view illustrating a radiator frame according to another embodiment;

FIG. 10 is a schematic cross-sectional view taken along line B-B′ of FIG. 9;

FIG. 11 is a schematic perspective view illustrating a connection terminal included in a radiator frame according to another embodiment;

FIG. 12 is a schematic perspective view illustrating a radiator frame according to another embodiment; and

FIG. 13 is a schematic cross-sectional view taken along line C-C′ of FIG. 12.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

The terminology used herein is for describing particular embodiments only and is not intended to be limiting of the following description. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

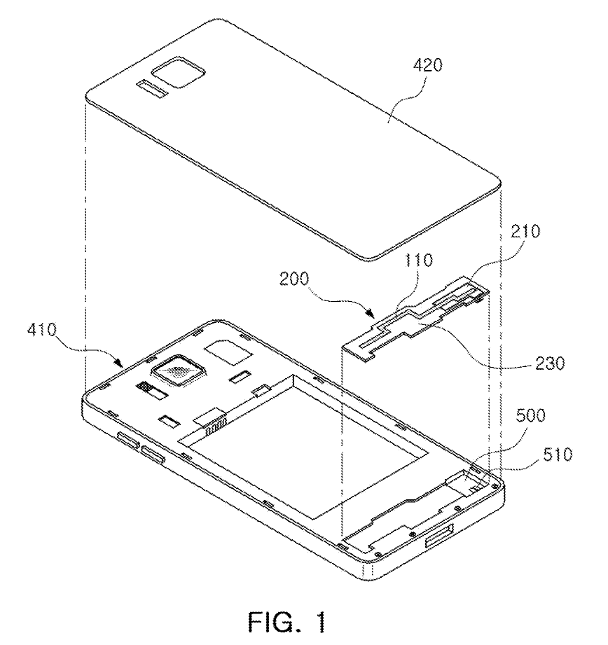

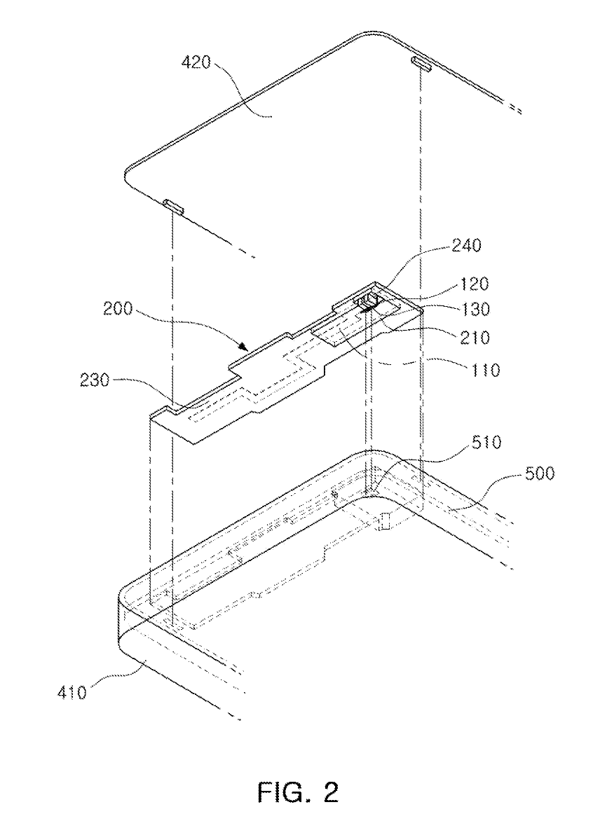

Referring to FIGS. 1 and 2, a mobile communications apparatus 400 according to an embodiment includes a case 410 forming an outer portion and a battery cover 420 covering a battery mounting part and a radiator frame 200.

The radiator frame 200 includes a molded frame 210 in which a connection terminal 130 is embedded to expose both sides thereof, an extension frame 230 surrounding an edge of the molded frame 210, and an antenna pattern 110 electrically connected to the connection terminal 130. The antenna pattern 110 extends from one side of the molded frame 210 to a side of the extension frame 230 opposite the molded frame 210.

The molded frame 210 may be formed by injecting molding the frame around the connection terminal 130. A size of the molded frame 210 is slightly greater than the connection terminal 130 in order to improve manufacturing yield and reliability of the molded frame 210.

Further, since the molded frame 210, the size of which may be insufficient to form the antenna pattern 110, is complemented by the extension frame 230 surrounding the molded frame 210 and extending laterally, flexibility in the manufacturing process and productivity may be improved.

The antenna pattern 110 is electrically connected to a terminal 510 of a circuit board 500 through the connection terminal 130. Thereby, the connection terminal 130 connects to the terminal 510 of the circuit board 500, and the radiator frame 200, when installed in the mobile communications apparatus 400, implements antenna performance in the mobile communications apparatus 400. The connection terminal 130 forms an elastic contact with the terminal 510 in order to ensure reliability in connection with the terminal 510.

When the antenna pattern 110 is installed in an electronic device such as the mobile communications apparatus 400, the antenna pattern 110 is externally exposed if it is not covered by the battery cover 420. Accordingly, a protection film (not shown) may be disposed on a surface of the radiator frame 200, on which the antenna pattern 110 is exposed, or on the antenna pattern 110. The protection film (not shown) is applied by spraying a liquid, such as paint in a painting process, or by disposing a film onto the antenna patter 110 or radiator frame 200.

The molded frame 210 a radiator frame 200 may be fabricated by an injection-molding method using a connection terminal 130, and an antenna pattern 110 may be formed on one surface 210a of the molded frame 210 and electrically connected to the connection terminal 130. In other words, the radiator frame 200 includes the antenna pattern 110 for transmitting or receiving a signal, and a connection terminal 130 for allowing a circuit board 500 of an electronic device to transmit or receive the signal.

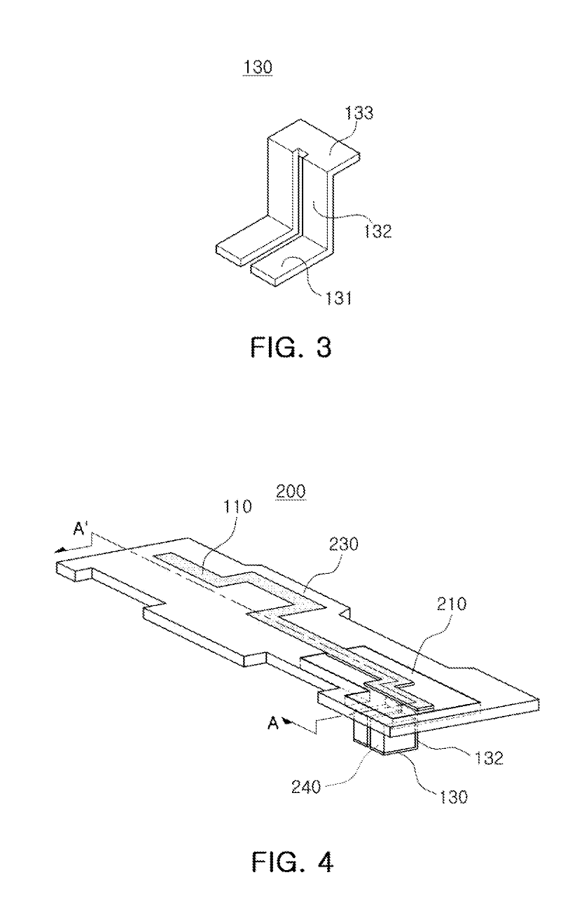

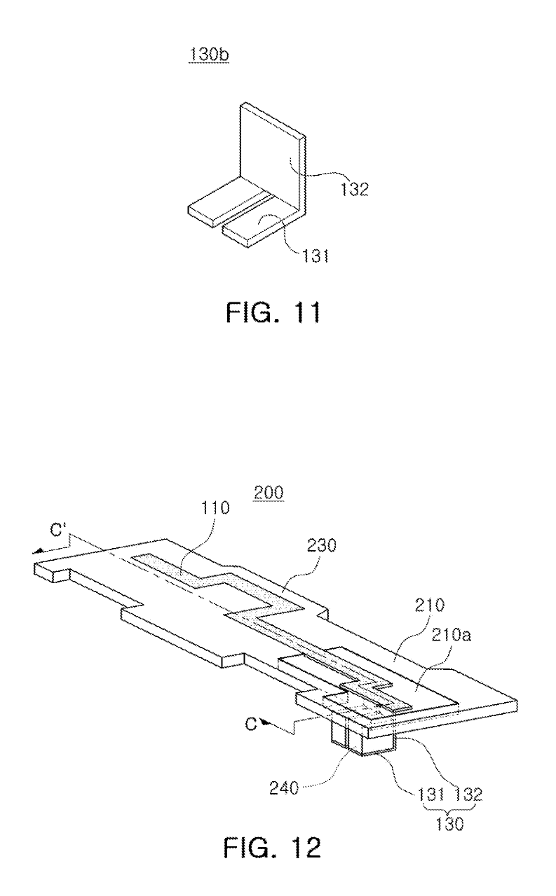

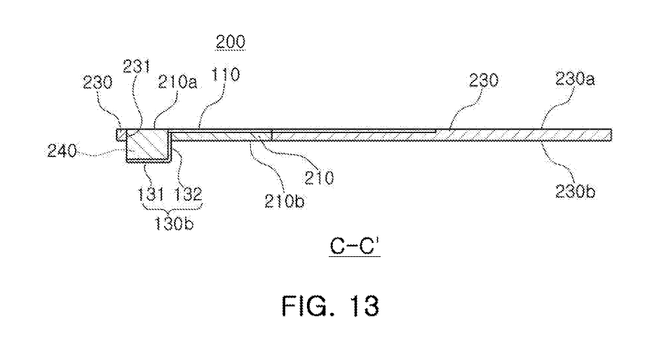

Referring to FIGS. 11-13, the connection terminal 130b of the radiator frame 200 includes a connection part 132 extending through the molded frame 210 from one surface 210a of the molded frame 210, through an opposite surface 210b of the molded frame 210 to a terminal part 131. The terminal part 131 extends from an end of the connection part 132. That is, the terminal part 131 may have an ‘L’-shape. Alternatively, the terminal part 131 may have a ‘ [symbol] ’ or stepped shape as illustrated in FIG. 3 or a ‘ [symbol] ’, ‘∩’, or ‘C’ shape as illustrated in FIG. 8 (reference numeral 131 a), where the terminal part 131 includes a contact-extension part 133 extending from the connection part 132 along the surface 210a of the molding frame 210 and disposed on the one surface 210a of the molding frame 210.

The antenna pattern 110 is formed of a conductive material, such as aluminum or copper, and receives an external signal and transmits the signal to a signal processing device of an electronic apparatus, such as the mobile communications apparatus 400. In addition, the antenna pattern 110 has meandering shape so to be capable of receiving external signals within various bands.

The connection terminal 130 transmits the signal received via the antenna pattern 110 to the circuit board 500 of the electronic apparatus, or receives a signal to be externally transmitted from circuit board 500 and transmit to the antenna pattern 110. In order to ensure reliability in signal transmission, the connection terminal 130 elastically contacts the terminal 510 of the circuit board 500. In this regard, the connection terminal 130 may additionally include a component for ensuring elasticity. That is, when the radiator frame 200 in which the connection terminal 130 is embedded is injection-molded and the terminal part 131 is bent by applying an external force thereto in order to obtain elasticity. A reinforcing part 240, such as a reinforcing block, may be formed by compressing a surface on another surface at a boundary between the connection part 132 and the terminal part 131 to ensure elasticity of the terminal part 131.

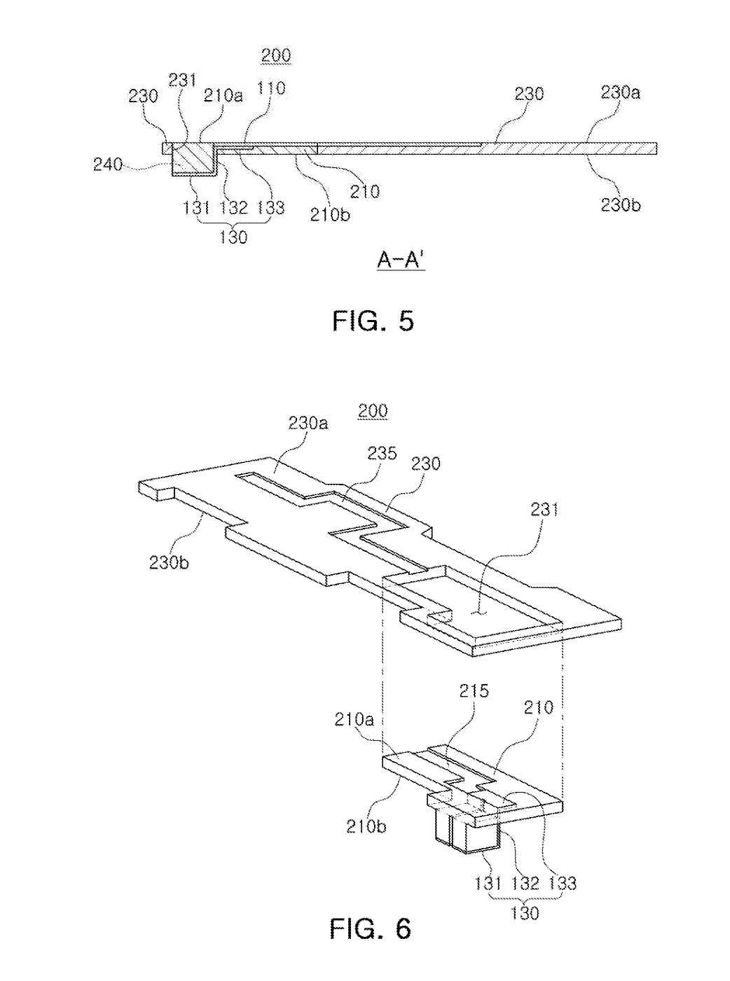

Referring to FIGS. 4 to 6, a radiator frame 200 includes an antenna pattern 110, a molded frame 210, and an extension frame 230. The molded frame 210 may be fabricated by an injection molding the molded frame 210 around a connection terminal 130. The connection terminal 130 is elastic. That is, the connection terminal 130, embedded during the injection molding process, has a terminal part 131 that may be rotated and bent to be offset from the molded frame 210. In this manner, the connection terminal 130 has an elastic structure, and the terminal part 131 has elasticity. In addition, the radiator frame 200 includes the extension frame 230 surrounding an edge of the molded frame 210.

The extension frame 230 is fabricated separately to the molded frame 210. For example, the extension frame 230 is fabricated by an injection molding process, but is not limited thereto. The extension frame 230 may be fabricated in various methods. Further, the extension frame 230 includes a holding part 231 into which the molded frame 210 is fixedly inserted. The holding part 231 comprises a hole formed in the extension frame 230.

In this case, the holding part 231 of the extension frame 230 may be a hole having the same shape as the edge of the molded frame 210. In other words, the shape of the holding part 230 corresponds to the shape to the molded frame 210.

In addition, the molded frame 210 is fixedly inserted into the holding part 231 of the extension frame 230. For example, the molded frame 210 may be slid into and coupled to the holding part 231 of the extension frame 230, and fixed by a bonding process using an adhesive. Alternatively, the molded frame 210 may be fixed in the holding part 231 of the extension frame 230 by push-fit coupling, or interference-fit. An additional bonding process using an adhesive may be performed in addition to the push-fit coupling, or interference-fit, process.

The extension frame 230 may be fabricated in an injection molding process with the molded frame 210 embedded during the molding process. In this case, the extension frame 230 integrated with the molded frame 210 is fabricated by fixing the previously fabricated molded frame 210 to a mold and injecting a liquid in the mold and solidifying the liquid. In addition, the liquid surrounds the entire molded frame 210, and thus the radiator frame 200, including the extension frame 230 surrounding the entire molded frame 210, is fabricated. Here, the material used to form the molded frame 210 and the extension frame 230 may be the same or different.

The antenna pattern 110 extends along one surface 210a of the molded frame 210 and one surface 230a of the extension frame 230, and the connection terminal 130 may be exposed on the one surface 210a of the molded frame 210 or the other surface 210b opposite thereto. In addition, the connection terminal 130 exposed on the one surface 210a is in contact with the antenna pattern 110 and electrically connected thereto.

Pattern grooves 215 and 235 are formed on the one surface 210a of the molded frame 210 and the one surface 230a of the extension frame 230. The antenna pattern 110 is formed in the pattern grooves 215 and 235. The pattern grooves 215 and 235 comprises recesses in the one surface 210a of the molded frame 210 and the one surface 230a of the extension frame 230. The pattern grooves 215 and 235 aligned at a position in which the molded frame 210 and the extension frame 230 are interconnected. In this case, one end of the connection terminal 130 is exposed in the pattern groove 215 of the molded frame 210. Here, when the antenna pattern 110 is formed in the pattern groove 215, the connection terminal 130 is connected to the antenna pattern 110.

When the antenna pattern 110 is formed by punching and bending a conductive material, such as aluminum or copper, or connecting pieces of the conductive material, the antenna pattern 110 is inserted into the pattern grooves 215 and 235 by a push-fit coupling process or a bonding process using an adhesive. When the antenna pattern 110 is inserted into the pattern grooves 215 and 235 by the bonding process, the antenna pattern 110 and the connection terminal 130 are connected to one another by a conductive adhesive. Additionally, the antenna pattern 110 may be printed or patterned (transferred) in the pattern grooves 215 and 235 with a conductive ink. In this case, the printing or patterning may be conducted once or several times.

Alternatively, during the process of fabricating the molded frame 210, the antenna pattern 110 may be formed by insert-injecting the connection terminal 130 using a laser direct structuring (LDS) resin as a resin material, forming the pattern grooves 215 and 235 having the shape of the antenna pattern 110 by laser-processing the one surface 210a of the molded frame 210 and the one surface 230a of the extension frame 230 in accordance with the shape of the antenna pattern 110 (a three-dimensional shape) preferably to be fabricated, and electroplating insides of the pattern grooves 215 and 235. In this case, the antenna pattern 110 and the connection terminal 130 are electrically connected to each other.

In addition, the metal, the conductive ink, or the electroplating pattern may be a different material from the connection terminal 130. In this case, in order to ensure a reliable connection between the different materials, a portion of the molded frame 210, at which the antenna pattern 110 is connected to the connection terminal 130, may be designed to have a concave shape (to be downwardly recessed), and a portion of the antenna pattern 110 connected to the connection terminal 130 may also have a concave shape recessed from the molded frame 210 so as to be resistant to external impacts. In addition, the concave-shaped portion of the antenna pattern 110 may be filled with a protective material, such as silicone.

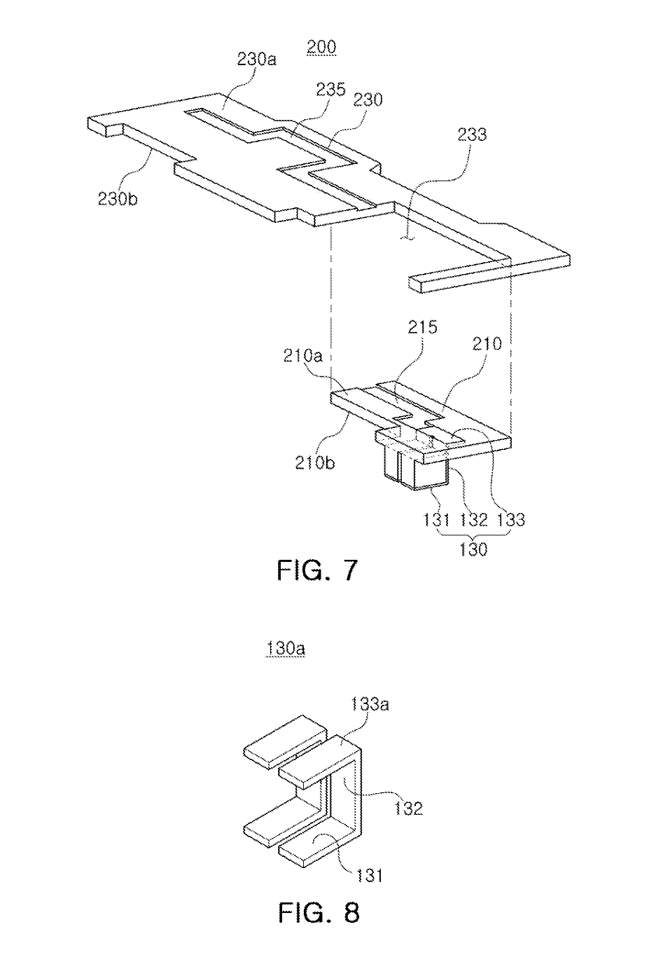

FIG. 7 is an exploded perspective view illustrating a radiator frame separated into a molded frame and an extension frame, without an antenna pattern, according to another embodiment.

As described with reference to FIGS. 4 to 6, a radiator frame 200 may include an extension frame 230 surrounding an edge of the molded frame 210. In this case, the extension frame 230 may include a holding part 231 for accommodating the molded frame 210 into the extension frame 230. The holding part 231 according to the embodiment illustrated in FIGS. 4 to 6 is a hole formed in the extension frame 230. However, a holding part 233 according to the embodiment illustrated in FIG. 7 has a similar shape as the holding part 231, but with an open edge or corner of the extension frame 230.

Referring to FIG. 7, the holding part 233 of the extension frame 230 may be formed in a groove, or hole having the same shape as a portion of the of the molded frame 210 and an open edge. In addition, the molded frame 210 is fixedly inserted into the holding part 233 of the extension frame 230. For example, the molded frame 210 may be slid into and coupled to the holding part 233 of the extension frame 230, and fixed thereto by a bonding process using an adhesive. Alternatively, the molded frame 210 may be fixed to the holding part 233 of the extension frame 230 by push-fit, or interference-fit, coupling. An additional bonding process may also be performed in addition to the push-fit, or interference-fit, coupling process.

The extension frame 230 may be formed by embedding the molded frame 210 during an injection molding process. In this case, the extension frame 230 is integrated with the molded frame 210 by fixing a previously fabricated molded frame 210 to a mold, and injecting an injection liquid into the mold. In addition, the injection liquid surrounds a portion of the molded frame 210, and thereby the radiator frame 200 including the extension frame 230 surrounding the portion of the edge, or perimeter, of the molded frame 210 may be fabricated. Here, the molded frame 210 and the extension frame 230 may be fabricated using the same material.

An antenna pattern 110 is disposed on one surface of the radiator frame 200, and pattern grooves 215 and 235 are formed on the one surface of the radiator frame 200 to accommodate the antenna pattern 110.

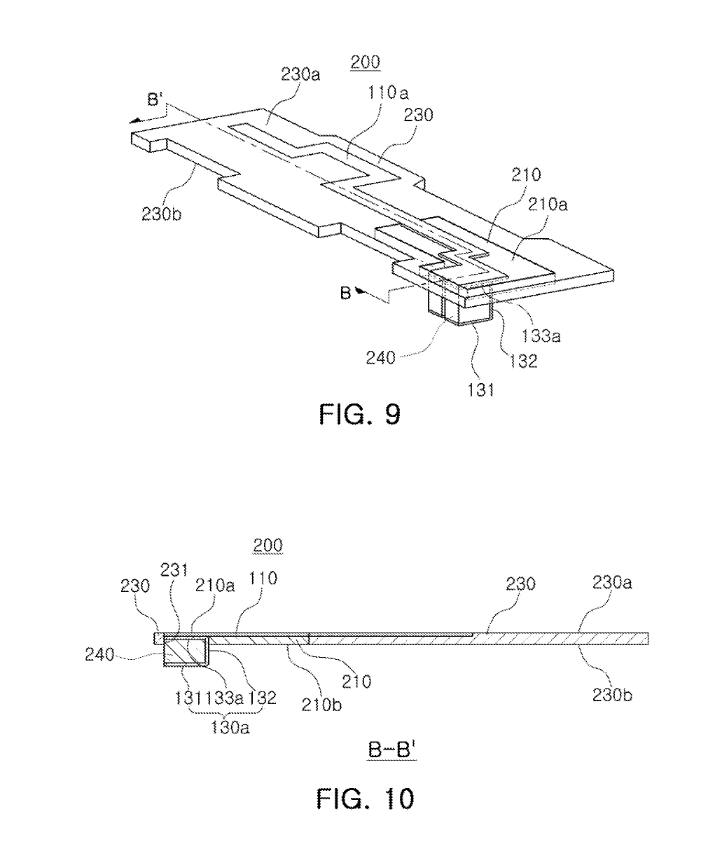

Referring to FIGS. 8 to 10, the radiator frame 200 includes a connection terminal 130a having a ‘C’ shape. The connection terminal 130a includes a terminal part 131 in contact with a circuit board, a connection part 132 extending through the molded frame 210 from one end of the terminal part 131, and a contact-extension part 133a extending from one end of the connection part 132 to be parallel to the terminal part 131.

When the connection terminal 130a has the ‘C’ shape, a shape of the antenna pattern 110a to cover and contact the contact-extension part 133a.

Referring to FIGS. 11 to 13, a radiator frame 200 includes a connection terminal 130b having an ‘L’ shape. The connection terminal 130b includes a terminal part 131 in contact with a circuit board, and a connection part 132 extending through the molded frame 210 from an end of the terminal part 131. When the connection terminal 130b has the ‘L’ shape, the connection part 132 is connected to the bottom surface of the antenna pattern 110.

As set forth above, a radiator frame capable of improving a manufacturing yield, and an electronic device including the same, can be provided.

As a non-exhaustive example only, a device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A radiator frame, comprising:
a molded frame;
a connection terminal extending from one surface of the molded frame and through another surface thereof;
an extension frame substantially surrounding the molded frame; and
an antenna pattern extending from the one surface of the molded frame to one surface of the extension frame and electrically connected to the connection terminal.

2. The radiator frame of claim 1, wherein the extension frame is integrated with the molded frame.

3. The radiator frame of claim 2, wherein the molded frame and the extension frame comprise the same material.

4. The radiator frame of claim 1, wherein the molded frame is disposed in a holding part of the extension frame.

5. The radiator frame of claim 4, wherein the holding part is a hole corresponding to an entire perimeter of the molded frame.

6. The radiator frame of claim 4, wherein the holding part is a hole corresponding to a portion of the edge of the molded frame, wherein the holding part comprises an open edge,

7. The radiator frame claim 4, wherein an adhesive is disposed between the molding frame and holding part of the extension frame.

8. The radiator frame of claim 4, wherein the molded frame is fixed to the holding part of the extension frame by push-fit or interference-coupling.

9. The radiator frame of claim 1, wherein the antenna pattern comprises a conductive ink and connected to the connection terminal.

10. The radiator frame of claim 1, wherein pattern grooves, configured to accommodate the antenna pattern, are disposed on the molded frame and the extension frame.

11. The radiator frame of claim 10, wherein an upper surface of the antenna pattern is coplanar with the one surface of the molded frame and the one surface of the extension frame.

12. The radiator frame of claim 1, wherein the connection terminal comprises:
a contact-extension part extending along the molded frame and exposed on the one surface of the molded frame and in contact with the antenna pattern,
a connection part extending through the molded frame from one end of the contact-extension part through the other surface of the molded frame, and
a terminal part extending from one end of the connection part parallel to the other surface of the molded frame.

13. The radiator frame of claim 12, wherein the antenna pattern is connected to at least a portion of the contact-extension part.

14. The radiator frame of claim 12, wherein the connection terminal has a ‘C’ shape or a stepped shape.

15. The radiator frame of claim 1, wherein the connection terminal comprises:
a connection part extending through the molded frame from one end of the contact-extension part through the other surface of the molded frame, and
a terminal part extending from one end of the connection part parallel to the other surface of the molded frame, wherein the connection terminal has an ‘L’ shape.

16. An electronic device, comprising:
an electronic device case;
a radiator frame installed in the electronic device case; and
a circuit board electrically connected to the radiator frame configured to receive a signal from the radiator frame or transmit a signal to the radiator frame, wherein the radiator frame comprises:
a molded frame,
a connection terminal extending from one surface of the molded frame and through another surface thereof,
an extension frame substantially surrounding the molded frame, and
an antenna pattern extending from the one surface of the molded frame to one surface of the extension frame and electrically connected to the connection terminal.

17. A method of fabricating a radiator frame comprising:
injection-molding a molded frame around a connection terminal;
injection-molding an extension frame around the molded frame;
disposing an antenna pattern in a groove pattern formed on an upper surface of the molded frame and extension frame.

18. The method of claim 17, wherein the antenna pattern is disposed on the upper surface of the molded frame and the one surface of the extension frame by screen-printing or electroplating using a conductive material and connected to the connection terminal.
